(19) United States
(12) Patent Application Publication
(10) Pub. No.: US 2008/0181513 A1
(43) Pub. Date: Jul. 31, 2008

(54) Method, apparatus and algorithm for indexing, searching, retrieval of digital stream by the use of summed partitions

(76) Inventor: John Almeida, Berkeley, CA (US)

Correspondence Address: LOUIS VENTRE JR, 2483 Oakton Hills Dr., OAKTON, VA, 22124, US

(21) Appl. No.: 11/682,316

(22) Filed: Mar. 6, 2007

Related U.S. Application Data
(63) Continuation-in-part of application No. 11/669,822, filed on Jan. 31, 2007, now abandoned.

(51) Int. Cl. G06K 9/62

(52) U.S. Cl. 382/224

(57) ABSTRACT

A method and apparatus for indexing, searching and matching still images, digital audio, video images, text or any kind of digital stream where rules like color change and filtering are applied to images before their indexations, then they are partitioned and a means for producing individual values for each partition is applied (checksum) and the values are saved into a searchable database. The same rules are applied at the input digital stream as to produce identical values for the selected partitions of the input of digital stream then perform a search and match against partition values digital stream stored at the database. As well means for associating content to a digital-content stream based on the digital stream partition's values, time related content to the content stream presentation, user supplied descriptive words related to the content stream and embedded information within the content stream.

### CROSS REFERENCE TO RELATED APPLICATION

The present application is a continuation-in-part of U.S. patent application Ser. No. 11/669,822, filed Jan. 31, 2007, titled “Method, apparatus and algorithm for indexing, searching, retrieval of digital stream (audio, video, images and text) by the use of summed partitions”, the entire disclosure is incorporated herein by reference.

### BACKGROUND OF THE INVENTION

1. Field of the Invention

The field of this invention relates generally to a method and algorithm for representing the indexing, searching, retrieval and recognition of still images, text, audio and videos by applying a checksum or any other means to produce unique values of sequential blocks across the digital stream.

2. Prior Art

Prior art Bober U.S. Pat. No. 7,162,105 teaches a method of representing an object appearing in a still or video image, by processing signals corresponding to the image, the method comprises deriving a plurality of numerical values associated with features appearing on the outline of an object starting from an arbitrary point on the outline and applying a predetermined ordering to the values to arrive at a representation of the outline. It further teaches a method of searching for an object in a still or video image by processing signals corresponding to images, the method comprises inputting a query in the form of a two-dimensional outline, deriving a descriptor of the outline, obtaining a descriptor of objects in stored images derived and comparing the query descriptor with each descriptor for a stored object, and selecting and displaying at least one result corresponding to an image containing an object for which the comparison indicates a degree of similarity between the query and said object.

Although Bober '105 teaches a method for indexing, searching and retrieving images from a database based on their outlines. Bober '105 is complex and prone to inaccuracies for the simple fact that computers don't do well in recognizing data based on their appearances even when complex mathematical formulas are used. Computers, on the other hand, do extremely well in dealing with numerical value representations that correlates to the actual underlying values, images' contours in this case. Bober '105 fails however to offer a solution for recognizing images and videos using an easy to implement and inexpensive solution without requiring a great deal of expertise and complexities.

It is the intent of the present invention to offer a highly accurate solution for the indexing, searching, recognition and retrieval of still images and videos that is easy and inexpensive to implement.

### SUMMARY OF THE INVENTION

It is the objective of the present invention to offer a highly accurate solution for the indexing, searching, recognition and retrieval of still images, text, digital audio and videos that is easy and inexpensive to implement by partitioning the image into smaller partitions then applying checksum across each partition of the digital stream thus producing individual values for each section for indexing, searching and retrieval, also, by manipulating the image as to produce values that correlates to close matches of the images sections in the storage medium.

In one preferred embodiment of this invention a digital stream (text, image, audio, video, etc.) is partitioned into one or more partitions, each partition is summed (checksum) and the resulting checksum value is used for the indexing of the pertaining digital stream, thus, enabling the summed partitions to be used as an easy and fast means for searching and retrieving the digital stream.

In one other preferred embodiment of this invention a user will be allowed to provide at least one information to a digital stream as it is displayed or just by providing the information in a provided text box for the purpose of relating parts of the digital stream with related content to be associated with two or more parts of the said digital stream. The related information can be based on the digital stream partition's values, portions of the digital stream in regards to time, user provided categorization values related to portions of the digital stream, related words to said portions, etc.

In yet another additional preferred embodiment of this invention means for providing the x-y axis ratios of image's contours to search other image contours based on their respective x-y axis ratios values.

Still in another preferred embodiment of this invention will offer means for relating content to a digital stream based on a user supplied information based on part or for the whole of the digital stream. Such offering will enable other related contents (advertisings) to be associated with the user provided digital stream.

### BRIEF DESCRIPTION OF THE DRAWINGS

The accompanying drawings, which are incorporated in the form a part of this specification, illustrate embodiments of the invention and, together with the description, serve to explain the principles of the invention:

FIG. 1 illustrates a preferred embodiment of this invention having an image partitioned.

FIG. 1a illustrates computing device hardware for executing software instructions along with Internet connecting devices.

FIG. 2-7 illustrate ways to partition images to produce differing values for the indexing, storing and retrieval of each image.

FIG. 8 illustrates an input image for locating an image at the database.

FIG. 9 illustrates the retrieved image from the input image of FIG. 8.

FIG. 10 illustrates the expanding (enlarging) of the image to produce different values for matching similar images at differing sizes.

FIG. 11 illustrates ways of skewing an image to produce differing contours by changing its angle on the image spectrum.

FIG. 12 illustrates the selection of the image section after it was skewed at FIG. 11.

FIG. 13 illustrates the selection of partitions of an image area and having the selection slightly moved up/down and left/right as to produce differing values for the underlying search.

FIG. 14 illustrates a further embodiment of FIG. 7 where more details of an image can be selected for input.

FIG. 15 illustrates two images, one is the used as input to search the other.

FIG. 15a illustrates the smaller image of FIG. 15.

FIG. 15b illustrates the larger image of FIG. 15.

FIG. 16 illustrates a larger image used as input-search to find a smaller image and producing an exactly match.

FIG. 17 illustrates x-y coordinate of both images of FIG. 16 used for producing their respective contours ratio.

FIG. 17a illustrates a table representing the contours ratio for the images of FIG. 17.

FIG. 18 illustrates a preferred embodiment and it is a means for locating images based on their contours ratio.

FIG. 19 illustrates a pure sine wave.

FIG. 20 illustrates the sine wave of FIG. 19 having its positive side converted to digital.

FIG. 21 illustrates partitioning applied to a digital audio envelope.

FIG. 22 illustrates partitioning applied to a text page.

FIG. 23 illustrates a preferred embodiment using partitioning of a video clip to relate contents to it.

FIG. 24 illustrates playtime of a video clip used for relating contents to it.

FIG. 25 illustrates user-supplied codes for relating contents to a video clip.

FIG. 26 illustrates the partitioning of text and image for relating contents to a text page and images.

FIG. 27 illustrates embedded information on pages used for relating contents to images and text pages.

FIG. 28 illustrates a digital audio envelope's playtime used for relating content to the digital audio stream.

FIG. 29 illustrates embedded user supplied data into a digital stream.

### DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

As will be appreciated by those of skill in the art, the present invention may be embodied as a method or a computer program product. Accordingly, the present invention may take a form of an entirely software embodiment or an embodiment combining software and hardware. Furthermore, the present invention may take the form of a computer program product on a computer-readable storage medium having computer-readable program code means embodied in the medium. Any computer readable medium may be utilized including but not limited to: hard disks, CD-ROMs, optical storage devices, or magnetic devices.

Also, any reference to names of a product or of a company is for the purpose of clarifying our discussion and they are registered to their respective owners.

In a preferred embodiment of this invention a method, apparatus and an algorithm (henceforth called algorithm) for subdividing a still image, digital audio and video (henceforth called images and digital stream and used here interchangeably) into smaller segments and having a checksum algorithm (or any other means to produce unique values for each partition) applied to each of the partitioned segment of the digital stream as to produce distinct values for indexing each part of the specific digital stream section will be presented. As well, means for selecting desired segments of the digital stream for input-searching; means for navigating the image within its spectrum as to produce differing input-search values; means for changing its orientation as to skew it then select part of the same thus producing differing input-search values; means for changing its dimensions (enlarge/reduce) selected area of the same for producing differing input-search values; and means for changing the orientation within selected areas as to produce differing input-search values and means for relating content to a digital-content stream.

I) Checksum Theory

A checksum algorithm is an algorithm used to produce mathematical sum representing a section of data, a data file, string, data packets, digital stream, etc. In our case, images and digital audio (digital stream) are partitioned and it is applied to each partitioned area of the images and its resulting value is placed into a database as indexing means for indexing the images they represent. An image can be partitioned into a single partition, that is, only one value will be produced for the complete image. Additionally, it can be partitioned into two or more partitions and the more it is partitioned the more values the partitioning process will produce, the more values, the more resolution of the image will be indexed, thus allowing better search of images at the database level.

Before we proceed any further lets give an example of a checksum for purpose of clarity, we'll be using the Adler-32 sum of the ASCII string “HELLO” and it would be calculated as follows:

| ASCII Code | String A | String B |
|---|---|---|
| H = 72 | 1 + 72 = 73 | 0 + 73 = 73 |
| E = 69 | 73 + 69 = 142 | 73 + 142 = 215 |
| L = 76 | 142 + 76 = 218 | 215 + 218 = 433 |
| L = 76 | 218 + 76 = 294 | 433 + 294 = 727 |
| O = 79 | 294 + 79 = 373 | 727 + 373 = 1100 |

String Checksum=3731100 (the values 373 and 1100)=>HEX=38EE9C

Each byte is represented as a value by a computer and in our example the bytes are letters of the Latin alphabet and they are represented by values of an alphabet table called ASCII (American Standard Code for Information Interchange). Each alphabet is represented by a table and having distinct value for each character of the represented alphabet. HEX (Hexadecimal) values are ways of converting values into the 16-value range format used to represent 0-9 (for 0-9) and for 10-15 (for A-F).

II) Partitioning of Images and Video

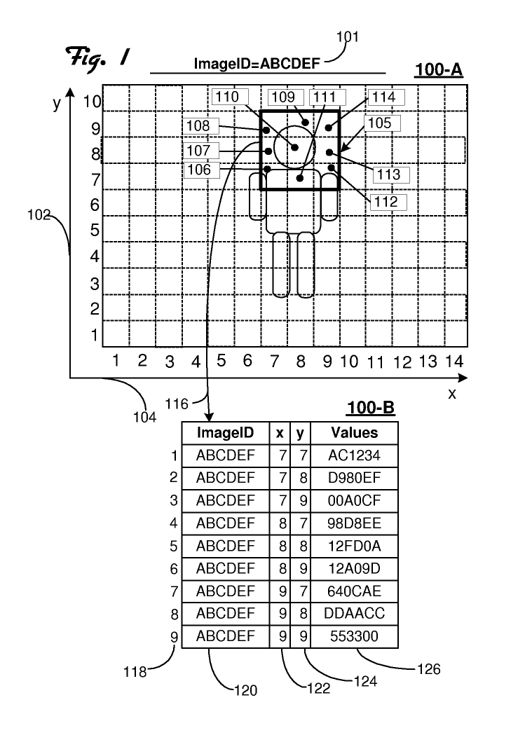

As we now turn to FIG. 1 it illustrates a preferred embodiment of this invention whereas an image spectrum 100-A and having an image on the same and represented by its x-y axis 104, 102 respectively. The x-axis 104 having 14 columns, the y-axis 102 having 10 rows, thus producing 140 sections of the image scale, and table 100-B illustrates individual partition values for six sections of the image 100-A. As we analyze table 100-B it illustrates four columns and they are: ImageID 120 (the same imageID 101 and it is the ID used for saving the image's checksum partitions at the database), x-axis 122 for the image x-axis 104 on the image plane 100-A, y-axis 124 for the image y-axis 102 on the image plane 100-A and values 126 for the individual image's checksum sections of the image's partitions (sections) on the image plane 100-A. All of the values 126 for table 100-A are fictitious values and not necessarily representing actual values of the image's spectrum. It is done as is for the purpose of explaining this invention and its mode of use and not in any way intented to obscure its true spirit, scope and meanings.

Not all of the values for the image on the plane 100-A are illustrated on the table 100-B because of the fact that it would create a very long table. The representation of table 100-B are only for x-y axis for six partitions of the image on plane 100-A and they are: x=7 & y=7 (row 1—118) for partition 106; x=7 & y=8 (row 2—118) for partition 107; x=7 & y=9 (row 3—118) for partition 108; x=8 & y=7 (row 4—118) for partition 111; x=8 & y=8 (row 5—118) for partition 110; x=8 & y=9 (row 6—118) for partition 109; x=9 & y=7 (row 7—118) for partition 112; x=9 & y=8 (row 8—118) for partition 113; x=9 & y=9 (row 9—118) for partition 114. The partitions are illustrated in a bold square 105 around the image on the image plane 100-A.

As we now turn to FIG. 1a it illustrates a computing device 100a that can be used for processing images as well as for the database device 120a and their relationship are illustrated by arrow 122a. Now as we view the device 100a it has a Central Processing Unit (CPU) 102a and it is the brain of the device controlling the device's functionalities. The device 100a has programming code means for its initialization at power up and it is usually stored in the permanent storage medium, and in this case it is in a Read Only Memory (ROM) 104a it can be stored in other permanent storage medium as well.

After power up the CPU 102a will read the programming code from the ROM 104a and starts processing it and it will load an Operating System (OS) 116a from the storage device 106a into the Read Access Memory (RAM) 112a. The OS 116a will load software applications 118a as needed into the RAM 112a and as applications 118a are executed and their interaction will be presented to the user at the display 110a (it can be part of the device or attached thereto). As needed the OS 116a will receive input from others devices that are interfaced with the device 100a by using its Input Output (IO) port 108a, the devices can be but not limited to: mouse, keyboard, touch screen, etc. It will send output to other interfacing devices as well, such as but not limited to: screen, printer, audio card, video card, etc.

Once the device 100a communicates with other devices attached thereto it will use the Network Interface 11 4a. Now database 120a can be integrated as part of device 100a or it can reside at another location and be attached to the device 100a by the network interface 11 4a. In case it resides at a different location other than device 100a the computing device handling the database 116a will have similar functionality as of device 100a. As well, the Internet devices doing all the communication between client 128a and server 124b through the Internet connection 128a will have a similar device circuitry as the device 100a.

There are different reasons for partitioning an image into smaller or greater number of partitions. Lets say that we know exactly the image we want to retrieve from the database. Lets further assume that this particular image is part of a movie clip, and the movie cannot to be played to a specific audience, in this situation, the movie (sequence of images—photographs) will simply be saved based on a single value for each image composing the movie. The same can be said for still images (photographs) that need to be restricted and a single partitioning process can be used as well.

There are still other situations that the image doesn't need to be partitioned into many partitions, for instance, a movie is to be blocked from a movie sharing site, in this case a few partitions can accomplish the task. As aforementioned, the more partition of an image the more resolution can be retained for indexing and searching the image, and by using other techniques such as, skewing the image, by changing its dimensions, by changing its color range, etc., the more accurate the search and retrieval of the image will be. In the case of movie clip it may be necessary to partition the clip at every other frame without having all frames (images) partitioned.

The same mode used when portioning an image for its indexation must be used for performing a search as well. Lets say that an image is changed to its grayscale values, partitioned then saved. To be able to find the image the same steps must be taken with the input image, that is, change it to its grayscale then select areas of the partitioned image and initiate the search. If an image is partitioned into four partitions and its color range is the gray-scale range, the same needs to be done to the image that is used an input for the search, it must be converted to its gray-scale range, select four partitions for the image, then select the section(s) that will be used for the search.

Once sections of the input image are selected, the algorithm will produce the value(s) for the partition(s) and lastly, initiate the search. Converting color images to their grayscale values are a good way of producing more accurate searches, since color from one image may have different contrast in another identical image and by graying it, those inconsistencies will be reduce or removed, also, if the image is a high resolution one, it can be converted to a lower resolution, like from 2 bytes (65536 colors) to 1 byte (256 colors) value. If the image has any active filter, layers, special effects, etc., if they are left on the image and indexed, the same must be present on the input image as well. It is a good idea but not a prerequisite, to remove any of these special parameters, place the image in a memory, partition it then have its partitioned areas summed and saved. The same must be done to the input images as well. These changes are done for the indexing of the image only, the image itself will be saved as is without applying any rules, that is, it will be saved in its original format.

The algorithm of this invention can be used in any conceivable way possible. The same image can be partitioned and saved in many different forms. For instance, one can be in its original color values, another its colors can be masked as to have only its green, blue or red equivalents, yet another a filter can be applied to it to produce its black and white equivalent, its gray equivalent, and so on. The image can be saved in many different formats and in any number of partitions as well. The only requirement is that formats used for its indexing be used for its retrieval as well. The algorithm can be programmed to pass the input image directly to the database housing the stored images and the database can be programmed to apply all the rules onto the image and return the closest matches to the client computer.

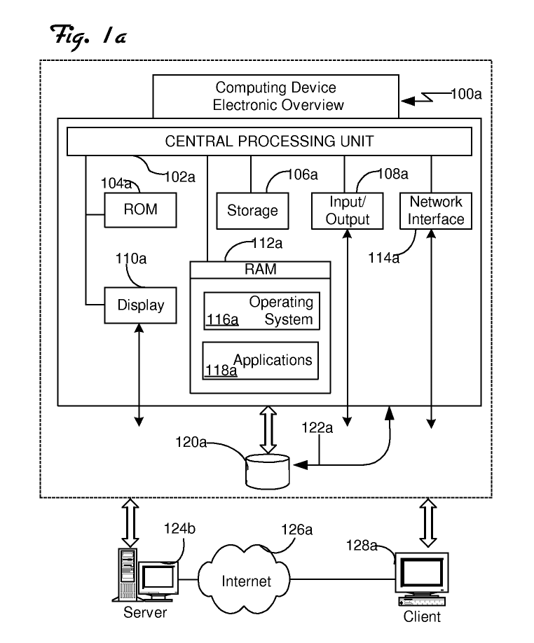

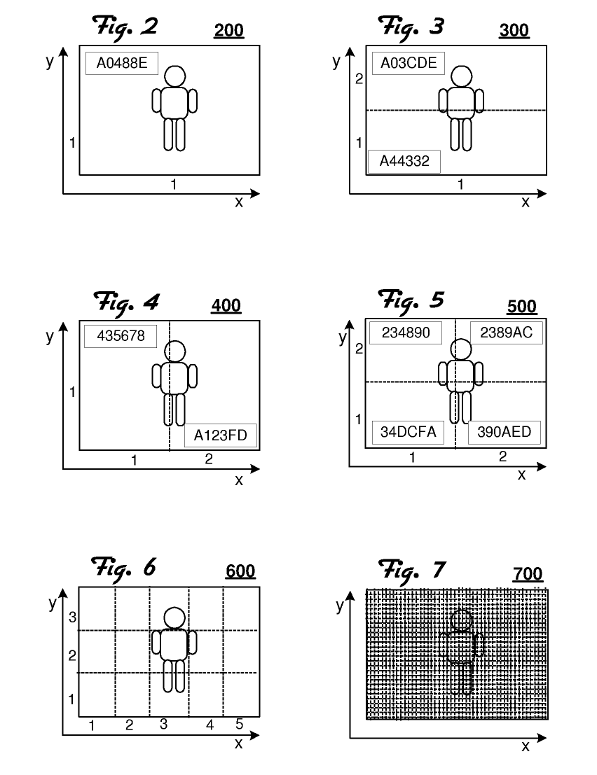

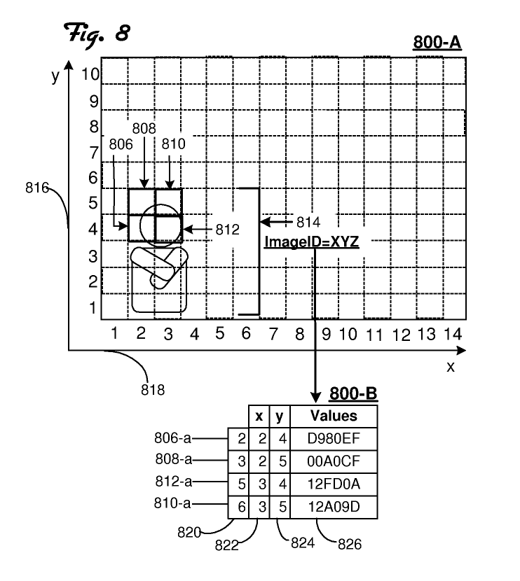

As we proceed and turn to FIG. 2 it illustrates an image spectrum 200 without any partition, that is, the whole image is used for its indexing, it can be said that it has one partition; FIG. 3 illustrates the image's spectrum 300 partitioned into two horizontal partitions; FIG. 4 illustrates spectrum 400 partitioned into two vertical partitions; FIG. 5 illustrates spectrum 500 partitioned into four quarters; FIG. 6 illustrates spectrum 600 partitioned into 15 partitions; and FIG. 7 illustrates a greater number of partitions as to produce greater details for the indexing and searching of the image. As images are partitioned as per the illustrations of FIG. 2-7, each type of partitioning can be saved into different tables as to facilitate the searching algorithm or they all can be saved on a single table as well. Once again, before images are partitioned any kind of available filtering, removing of color range, change of its color range, producing its grayscale equivalent, producing a low resolution, contour, outline, etc. can be applied for the purpose of creating more than one range of values for the indexing, searching and its recognition using more than one sample of the input image, this process will be explained shortly.

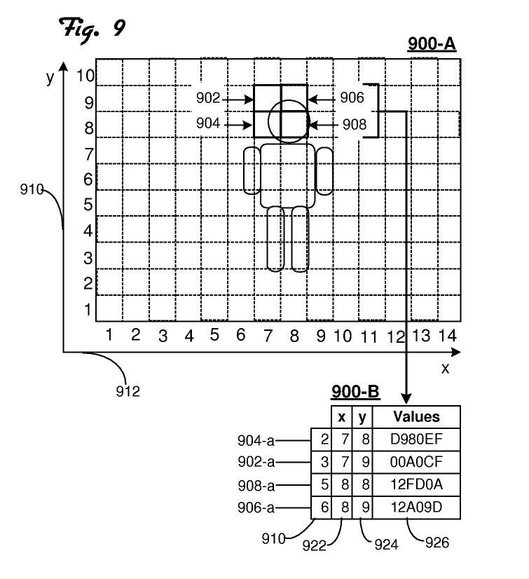

Lets keep FIG. 1, FIG. 8 and FIG. 9 handy. The image of FIG. 8 is the input source for finding the values of FIG. 9, and FIG. 9 is a copy of FIG. 1 illustrating the matching areas. Now as we proceed and turn to FIG. 8 and it illustrates the image plane 800-A and it is now being used as an input image for searching the database table that we've reviewed at FIG. 1. The database table 800-B presents only four rows (2, 3, 5 and 6—820) from the original table 100-B of FIG. 1 and it has the same rows (2, 3, 5 and 6—118 of FIG. 1). They represent the partitions of the input image 814 and it has for row 2 820 (806-a—806); for row 3 820 (808-a—808); for row 5 820 (812-a—812) and for row 6 820 (810-a—810). As illustrated by the input image 814 on plane 800-A, four of its partitions have been selected and they will be used as an input to search the image in the database, partitions 806, 808, 810 and 812.

The algorithm will produce the same values as was originally produced and saved (FIG. 1). For partition 806 (806-a) the value of “D980EF” 826 (row 2—820); for partition 808 (808-a) the value of “00A0CF” 826 (row 3—820); for partition 812 (812-a) the value of “12FD0A” 826 (row 5—820) and for partition 810 (810-a) the value of “12A09D” 826 (row 6—820). All the values represented at column 826 are in hex format (0-9 and A-F representing values from 0-15) but it can be in any format without departing from the true spirit of this invention. Throughout, we've used the term checksum to produce unique values for each partition. It can be any format that will produce a unique value for each partition, any means now in use or later to be conceived. We're explaining this invention and using checksum for the simple reason that it is well know to those skilled in the art.

After the user finishes selecting the partitions of the input image 800-A the algorithm will produce the aforementioned values and they are the illustrated results of table 800-B and once he/she initiates some kind of query request the query request will be sent to the database storing the images and their respective indexations then the database will match the input values with the database table 100-B of FIG. 1, next, locate the matches located at table 900-B of FIG. 9 (copied from FIG. 1), and since it is a perfect match the image “ABCDEF” will be returned to the user. The request can be in any database query format, other formats can be used as well, for instance, after the selection, the image along with the selection can be send to the database and it will do all the search and apply rules (skewing the image, changing its colors, applying filters, etc.). Every time the mode of the input image changes the algorithm will reproduce the new values and apply a new search against the database for the new value(s).

There are moments that an image has a different size than the image used as input values, in this case, after selecting the area of the image to produce the input values, the image can be resized to produce different input values and as each resizing the algorithm can produce new search. As aforementioned, all of these interactions can be done at the client computer and passed to the database, or, the algorithm can be implemented at the database level and the client computer will pass the image with its selected partitions. The whole image can be resized as well instead of just the selected input areas.

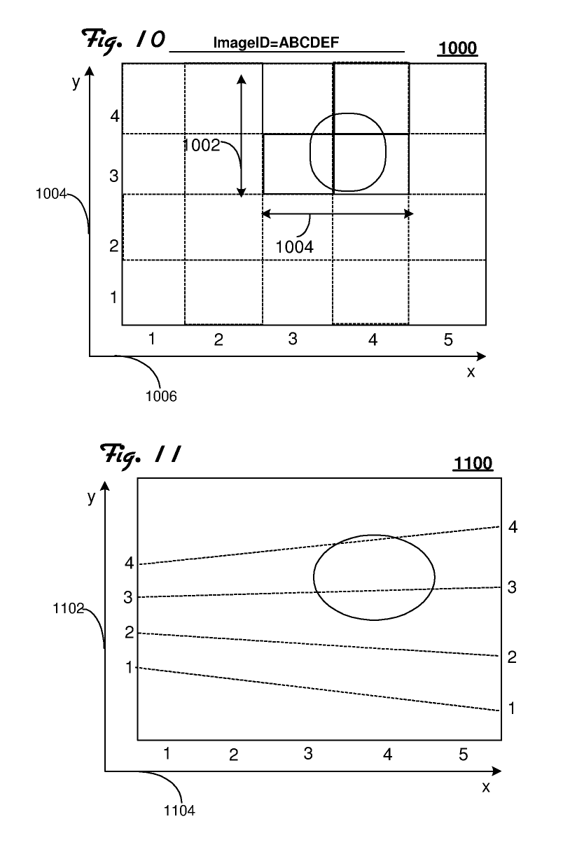

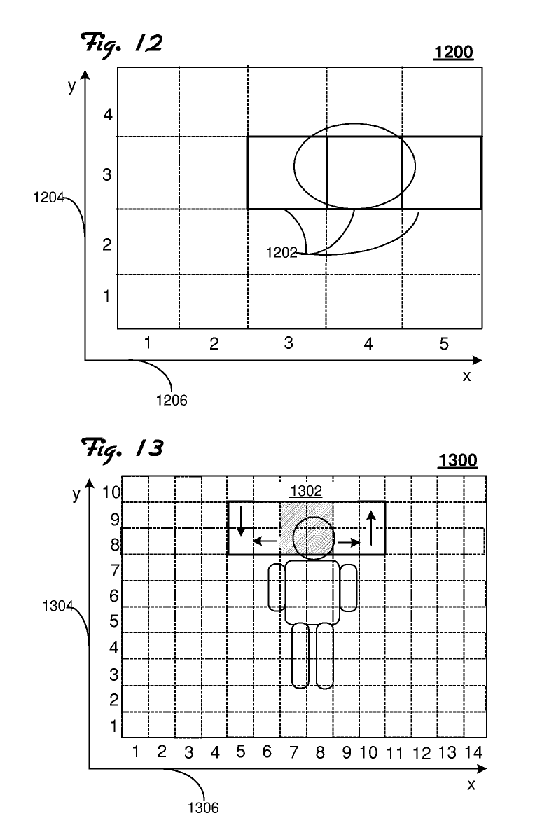

As we turn to FIG. 10 it illustrates the image plane 1000 and the previous selected area expanded (increased) 1002 and 1004. The same can be done to decrease the image size and have new sets of input values. FIG. 11 illustrates but one more way and this time the input image is skewed from its y-axis 1102. The image can be skewed in any desired angle. The purpose of skewing, resizing, changing color-range, etc. (rules), is for producing various input values from the input image. Now, FIG. 12 illustrates selection of partitions of the image 1202 after it was skewed (FIG. 11). Lets now turn to FIG. 13 and it illustrates but one other way of producing more input values for locating images on the database. This time after the areas/partitions are selected the algorithm will move the selection (shaded squares) up/down and left/right within a specified area 1302. And once again, more input values will be produced for the search of images.

As aforementioned, the higher degree an image is partitioned when it is indexed, the more resolution of it will be saved, thus providing more relevant values for locating more details of stored images at the database. As we now turn to FIG. 14 it is a further embodiment of FIG. 7 on a larger image plane 1400. It illustrates selections 1402 and as we analyze it, the selection involves selecting the contour of the image and as per our example it is the head part of the drawing. In reality, after an image is indexed with a higher number of partitions, it is possible to select just specific areas, like, if the image is a person, select a group of specific areas of the nose, mouth, eye, etc. On the other hand if the image is a structure like a bridge, selection of parts of pillars, cross-sections, arches, etc.

As we've aforementioned, before an image is used for input, rules are applied to it (resized, skewed, reshaped, filtered, etc.), as to produce various input values. Also, before the image is indexed its settings can be changed to its equivalent gray-scale, contour equivalent, (distinct RGB values) green colors only, blue colors only, red colors only, black and white, etc., and the same applied to the input image as to produce various matching values for the searching underlay algorithm. As we saw in FIG. 9 the matched values of FIG. 8 were precise matches except their x-y axis. Additionally, it illustrates that the algorithm can find similar images with different x-y axis.

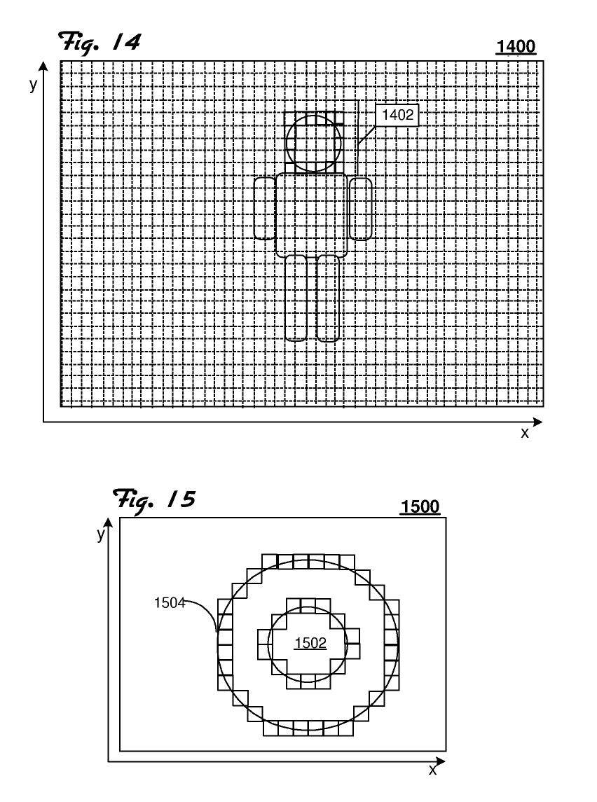

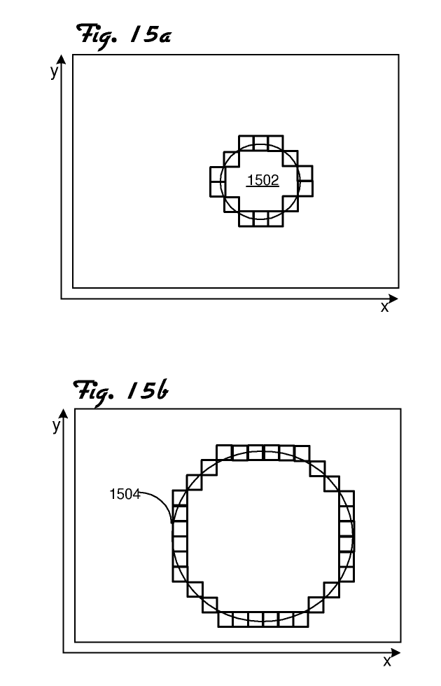

It is possible however to have images with the same or similar shapes and having differing sizes to be matched without doing all of the resizing and reshaping as previously described (applying rules). As we now turn to FIG. 15 it illustrates but one more way of using the algorithm to accomplish just that. There are two images on plane 1500 and they are 1504 and 1502. The image 1502 is the smaller of the two and they both having the same shape and both are indexed on the database. In this example, both images are on a single plane, they can as well be two distinct images and saved/indexed using two distinct names.

Lets take two suppositions:
1) The first one, the smaller image 1502 is used as the source for the input and the larger image 1504 as the search target. Now the smaller image's 1502 partitions values will be matched to some partition values of the larger image 1504, since the larger image 1504 has more partitions than the smaller one 1502. If the number of matched values equal a specified threshold of the smaller image 1502, lets say that 90% of the input values of the smaller image 1502 are matched against the indexed values of the larger image 1504, then the larger image 1504 is a close match to the smaller image 1502.
2) The second one is true when the larger image 1504 is used for the input values and the smaller one 1502 is the search target. In this instance, the opposite will happen, that is, 10% of the values of the larger image 1504 are matched against the smaller image 1502 and once the algorithm compares the percentage-threshold of the matched values of the smaller image 1502, and 90% of its values were matched against the search, the same is true as for the smaller image 1502, and it is a close match to the larger image 1504.

As we now turn our attention to FIG. 15a and FIG. 15b they illustrates the two images of FIG. 15 and they are in their respective image plane and indicating that they are two distinct images.

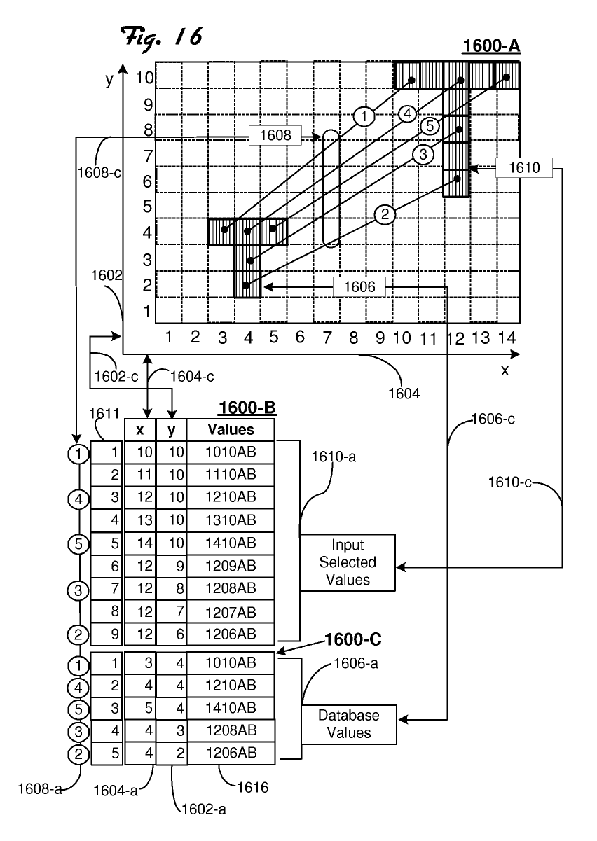

There is at least one more way of checking images correlations based on how close their contours are. Lets now turn to FIG. 16 and it illustrates the image plane 1600-A having two images 1610 and 1606 and interconnecting lines 1608 illustrates the correlating partitions between the two images. Table 1600-B illustrates the values for image 1610 (arrow line 1610-c) and table 1600-C illustrates the values for image 1606 (arrow line 1606-c). The x-axis column 1604-a, the y-axis column 1602-a, rows column 1611, relationships column 1608-a, and values column 1616 are common to both tables (1600-B and 1600-C).

The relationship column 1608-a is related to relationship 1608 image plane 1600-A and illustrated by the arrow line 1608-c. Column 1604-a is related to the x-axis 1604 of image plane 1600-A (arrow line 1604-c) and column 1602-a is related to y-axis 1602 of the image plane 1600-A (arrow 1602-c). And the column 1616 has the values for partitions of the input image 1610 of the image plane 1600A (table 1600-B) and the indexed image 1606 of the image plane 1600-A (table 1600-C). This column is of importance to our discussion, so lets focus our attention to it. Since the algorithm will produce values from the input image 1610 and the same values are indexed for the saved images, 1606 in this case. Their values have to be the same.

Lets review a couple relationship 1608 between the top image 1610 and bottom image 1606 of the image plane 1600-A. Lets take the relationship #1 (#1 inside the circle). It is represented by the relationship #1 1608-a for both tables, 1600-B and 1600-C. As we look at column 1611 at row #1 (1600-B) and row #1 (1600-C) we see this relationship (#1 inside circle for both rows) and as we analyze the values for both rows they both are “1010AB”. One more, lets review the relationship #2 and it is shown on column 1611 for rows #9 (1600-B) and #5 (1600-C) and the same value of “1206AB” for both tables.

Lets review one x-y value. Lets take row #1 of column 1611 (table 1600-B) and it has “10” for the x-axis 1604-a and “10” for the y-axis 1602-a. If we follow the x-axis 1604 to the 10th column and up to the y-axis 1602 to the 10th row we see that there is a selected partition of the image and it is the relationship #1 for image 1610. The same explanation applies to both images and their respective x-y axis and values are represented by each of their respective table (image 1610 at table 1600-B and image 1606 at table 1600-C). The values used are fictitious and not necessarily represent any actual values for the respective partition. They are used as is for sake of simplicity and not in any way intended to obscure this invention.

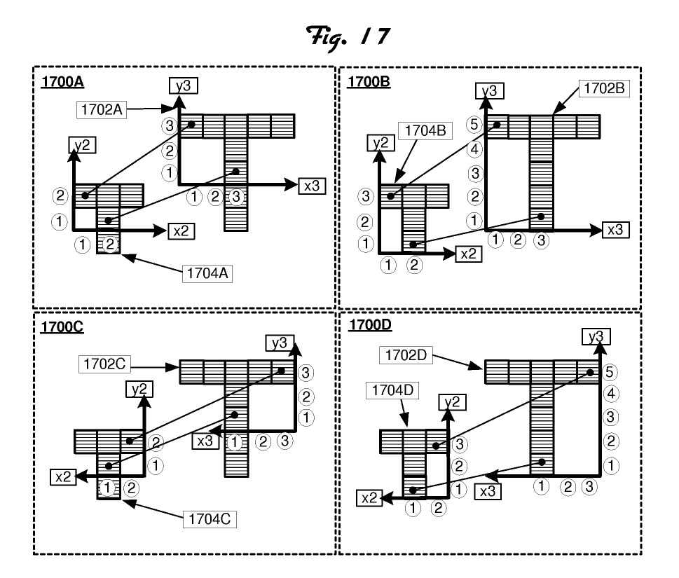

It is now clear that the algorithm can locate images of different sizes as per the teaching of FIGS. 15, 15a, 15b and 16. Additionally, the teaching of FIG. 16, the larger image was used as the input image for locating a smaller image, the opposite is true as well, that is, the smaller image can be used for locating the larger image. As aforementioned, the algorithm can be used for checking image's contours and as we turn our attention to FIG. 17, it illustrates the two images presented on FIG. 16 and for image 1610 of FIG. 16 it is the image 1702x; and for image 1606 of FIG. 16 is the image 1704x (“x” since it can be A, B, C and D for each box). Each relationship of the images of FIG. 16 is now represented in separate boxes and as we explain each one their meanings will become clear.

Now, the objective is to check each image contours for their appearances and similarities. Lets keep FIG. 17 and FIG. 17a handy. As we review image plane 1700A and it illustrates the contour of the larger image 1702A and having x3-y3 axis assigned to it and it has three columns for the x3-axis and three rows for the y3-axis. As for the smaller image 1704A it has two column for the x2-axis and two rows for the y2-axis. Let's move forward to FIG. 17a and it illustrates a table having column with rows 1714a, column 1712a with the values for each box of FIG. 17 and they are represented by the box label and for row #1 (FIG. 17) it has the label 1700A (FIG. 17) and it represents the x-y values for box 1700A of FIG. 17. Anyone educated in the art will know how to conceive the ideas being presented on FIG. 17. Since FIG. 16 shows both images in different locations of the x-y axis, their values will need to be subtracted as to move the image to the beginning of their respective x-y axis.

Next is the x2 column 1710-x2 representing the x2-axis of 1700A (FIG. 17); column 1710-y2 represents the y2-axis of 1700A; column 1706-x3 represents the x3-axis of 1700A; column 1706-y3 represents the y3-axis of 1700A (FIG. 17); column 1710-xy2 represents the divided values of column x2 (1710-x2) by column y2 (1710-y2); column 1706-xy3 represents the divided values of column x3 (1706-x3) by column y3 (1706-y3); and column 1724a illustrates the percentage difference between the contours of both images of each box of FIG. 17.

The percentage is taken by subtracting the value of column 1710-xy2 by 1706-xy3; the result multiplied by 100, then the result of the multiplication is divided by the value of column 1706-xy3. It can be done other ways as well that will accomplish a percentage between two values. The same explanation applies to all boxes of FIG. 17. As for box 1700B it is illustrated on row #2 1714a, for box 1700C row #3 1714a, and for box 1700D row #4 1714a. As for rows #1 and #3 they both produces “0” for their difference and it means that they are exactly match. As for rows #2 and #4 they have some small discrepancies once their values are subtracted (1710-xy2−1706-xy3) will produce the value of “0.07”, any value smaller than “0.1” can be ignored because it doesn't necessary represent discrepancies between the two images. It can be set to be other threshold besides being less than “0.1” as well without departing from the true spirit of this invention.

Before proceeding any further, lets review boxes 1700C and 1700D of FIG. 17. As we look at the boxes 1700A and 1700B we see that their respective x-y axis arrows are pointing to the right and as for 1700C and 1700D they are pointing to the left, in the reversed direction. The contour check will start from the top of the y-axis down to its beginning row-by-row. At every selected partition that is found at the y-axis the algorithm will look to the next partition of the x-axis that is selected and produce the division between the two. The division can be “x/y” or “y/x”, as long as the same process is applied to both images. The division process between the two coordinates will happen to all values, except the values that are on the same row of the y-axis or values on the same column of the x-axis coordinate. As we look back to FIG. 16 the values for correlations #1, #4 and #5 are not taken at FIG. 17, the same applies to correlations #4, #3 and #2.

Back to FIG. 17 and since the values for boxes 1700C and 1700D from the y-axis that are compared with the values of the x-axis are past the x-axis coordinates columns, their arrows are represented backwards to produce the same results as for those y-axis values that are before the x-axis values. Their end product will be the same. Other means can be devised and implemented as well. There is more that one way to apply the explanations given and arrive at the same results, or at other results that accomplishes the same intended end results. And this explanation is not to be interpreted as limiting in any way and those of the skill in the art will readily know how to implement this invention using other approaches without departing from its true spirit and scope.

As aforementioned, rules can be set for the search and retrieval of images as it was illustrated by FIG. 15, the same can be done as for the x-y axis of both images, as illustrated by FIGS. 16, 17 and 17a. Lets say that we apply both rules, the rule regarding the percentage of the input image being present on the target image and the rule of the percentage of similar relationship between the two images regarding their x-y axis division values. The first rule is applied and many images are retrieved and some may not have a strong relationship with the input image, now, by applying the second rule the remaining images for certain will have relationship with the input image.

For instance, if the first rule says that only images having 80% corresponding values with target images and 80% resemblance between the two images, we're certain that images not bearing any similarities will be left out from the list of images. Values for FIG. 17a produced “0%” between the two images, since they both were alike in terms of the ratios of their respective contours, but if they had differing contours, their ratio had been shown on the percentage column. So, thresholds for the algorithm can be set as to a percentage allowed between the contours of two images as to allow more or less images to be matched against the input image's contour.

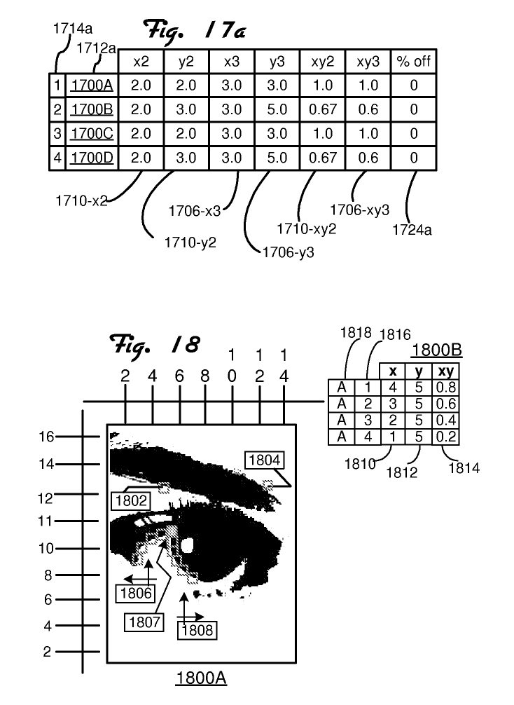

As we aforementioned, the algorithm can locate images based on their contours, appearances, likeness, etc., also, we've mentioned that the rules of the algorithm can set in a way as to produce differing values of images before indexing and saving them. As we turn now to FIG. 18 it is a preferred embodiment and it illustrates but one more way of using the algorithm to find images based on their contours. Since an image can be saved in its original colors, grayscale, black-and-white, etc. And in the case of a black-and-white images, or contour preset images, the algorithm can be set to save just the ratio of the differences between the y-axis values compared with the x-axis values of each image's contours as it was taught on FIG. 17a columns 1706-xy3 and 1710-xy2.

In the case that an image has just two distinct colors the algorithm will check for color changes, in the case of black-and-white, when it changes from black to white or when it changes from white to black. Whenever it happens, the algorithm will simply record the y-axis value and all of the x-axis values that is taking part of the ratio calculation and part of the particular color change. If the first color change is from white to black for the y-axis, the same is true for the x-axis. Now if we look at FIG. 18 (1802) it will record for that x-y axis since the color change from white to black, as for 1804 it will do the same since the color changed from black to white. As it is illustrated a few points in the drawing 1800A indicating that the algorithm is indeed recording each part of the contour, 1806 illustrates that the arrows are in reverse and 1808 illustrates them forward, as we've discussed on FIG. 17.

As we turn our attention to table 1800B it illustrates the image ID 1818, the row order 1816, the x-axis 1810, the y-axis 1812, and the x-y ratio for both columns 1814. The x-column 1810, y-column 1812 values are represented by the x-y axis 1806 of the drawing 1800A, they do not represent actual values and are approximate for sake of simplicity. As for y-axis 1812 it has the value of “5” for all rows 1816 and for the 1^{st} row 1816 the x-axis 1810 has the value of “4” and once the value of the x-axis 1810 is divided by the y-axis 1812 the result is the value of “0.8” 1814 and it is on the 1^{st} row 1816 of the “xy” column 1814, and it is the ratio between the two values. The values for x-y axis for table 1800B are taken for the x-y axis 1806 starting with the top box 1807 and to the left all the way to the last one down. The y-axis coordinate value of 1807 is recorded for all values of the x-axis coordinate values on the left of 1806 then the values (x-y) for each row is divided to produce the ratio between the two, so, each x-axis coordinate value will be used in calculating the ratio between each pixel location of the contour (x-axis) in relation the y-axis of the fixed y-axis pixel location of 1807. Once again, the values are fictitious and used here for illustration purpose and not intended to obscure the meanings of this invention.

Once a user initiates an input-search for images based on their contours, many values will be retrieved and they may not necessarily have any relationship with the input images. Once the values are retrieved from the database they can be grouped by the images' ID 1818 (ascending order), the y-axis 1812 (ascending order), the x-axis 1810 (descending order), by the row order 1816 (ascending order), this is shown on table 1800B of FIG. 18. Finally, they can be compared with the input values and the order that they appear in the retrieved result. It can be sorted in other ways as well without departing from the true spirit of this invention. The same rules presented for FIG. 18 applies to the input image used for searching indexed images, the areas will be selected the x-y axis ratio applied then the database searched.

As before, the threshold can set in any conceivable way and based on the percentage of contours-like, contours-ratio, partition-matches, etc. Regarding the contours of FIG. 18, once contours of the input image is selected, their respective ratios based on the y-axis versus the x-axis will be used to locate images with similar ratios without regard of their actual colors (without using partitions' values). The ratios can be set to be exactly match or a ratio-percentage that will represent a close resemblance between the input and the search-target images on the database.

III) Index and Retrieval of Digital Audio

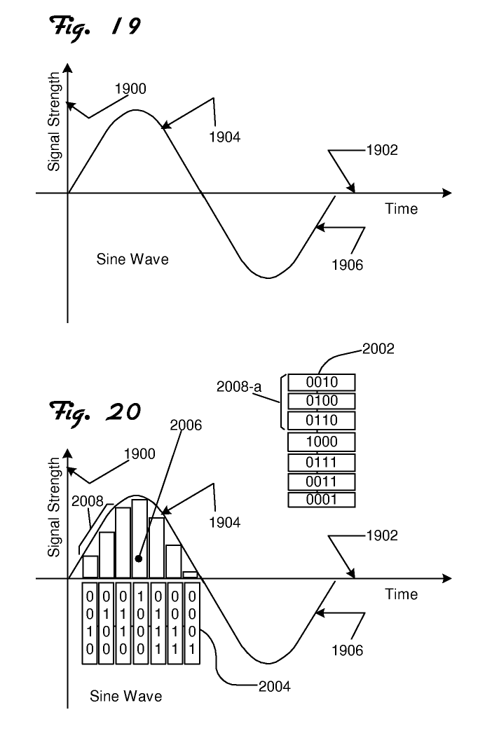

There is still at least one more way of using the partitioning means of the algorithm to accomplish the indexing and retrieval of digital stream and as we'll see shortly, it can be used for the purpose of indexing and search-retrieval of digital audio as well. As we now turn to FIG. 19 and it illustrates a pure sine wave. A sine wave is a way to represent information in the analog format—the old way of recording before the digital revolution and it is based on frequency shift for FM (Frequency Modulated) and based on amplitude shift for AM (Amplitude Modulated). A sine wave is presented on a plane having a time 1902 (the information in an specific time frame), the signal strength 1900 (it can be weak or strong), the upper side of the wave 1904 (positive), and the lower side 1906 (negative) of the waveform. As an analog wave is presented in a time sequence it is presented as an envelope, and the envelope has the positive and the negative sides of the analog wave.

Since computer don't understand variations other than variation dealing with zeros and ones, before a sine wave signal (analog format) can be handled by a computer it needs to be translated into a digital format of zeros and ones. There are many electronic circuitry used for converting analog signal to digital format and they are called “analog to digital converters—ADC”. As we turn our attention now to FIG. 20 it illustrates the positive side of the analog wave 1904 being converted to its digital-equivalent format. It illustrates the digital values 2004 (not actual values—used here for illustration purpose) and they are represented on table 2002. As we look at the positive side of the graph (sine wave) we see a bar graph 2006 and it illustrates how a computer converts the analog wave to the digital format and it does by taking samples of it, and the samples represent the digital equivalent 2004. The more samples the more accurate the digital information will be in relation to its analog counterpart.

As aforementioned regarding the partitioning of images, it was presented throughout that each partition of the image is summed as to create unique values representing the digital partition. As we'll see, the same can be accomplished with digital audio. Lets return our attention to FIG. 20 and as we inspect the positive side of the wave, it illustrates a range 2008 and the same 2008-a at the table 2002. With a digital-audio stream the partition may take place at specific areas of the frequency (changes on the signal in relation to time) spectrum. In the case of images we know where each image stats and ends, and since video is a sequence of images the same applies therewith.

Now with digital audio the algorithm will start partitioning the stream once a specified range (threshold) happens, it can be anywhere on the digital stream. As long it is specific and once the threshold happens the partitioning will begin then proceed thereon. In our illustration it will happen once the values happens to be “0010”, “0100” and “0110”, this is but one way, it tells the algorithm that once the first two values happens and if the third value happens to be the last one of the three-threshold values (it can be set in any way and any number of individual values) it will start partitioning. The partition can be of any length, and since the partitioning will happen at a precise threshold, it wouldn't matter how the digital—audio stream starts and ends. We've used a four bits length for our illustration, in reality it is the minimum of eight bits (one byte), it can be any number of bytes, however.

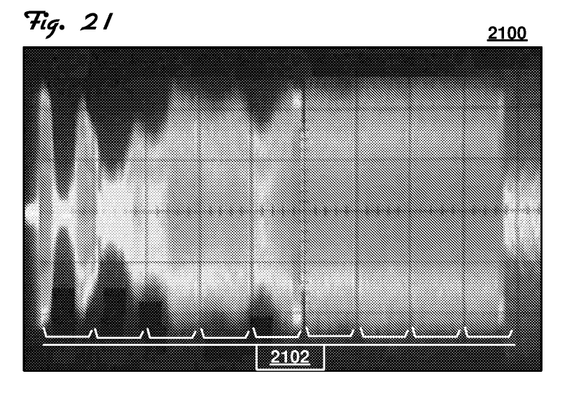

The same process (rules) that is used for partitioning the digital-audio stream for indexing must be used when performing the search as well. In the case of images we see the images on the computer screen, however with a digital audio, the digital-audio envelope is used to perform the partitioning of the audio stream. As we now turn our attention to FIG. 21 it illustrates what we've just described and it has the digital-audio stream envelope 2100 and it's partitioning 2102. This is but one-way of partitioning a digital-audio stream. It can be partitioned in other ways as well, like, by partitioning the positive and the negative sides of the digital envelope, into four partitions, etc. Instead of partitioning a digital-audio stream based on a specific threshold its partitioning can start right at the beginning of the stream or at any other predetermined location. It is presented as is for sake of simplicity and not intended to obscure this invention.

As explained throughout this disclosure filtering can be applied to images before indexing, their color mode changed, their outlined produced, etc., than applying the indexing rules and they can be one or more partitions, the more partitions the more details values are indexed for the image. If the image requires just a simple mechanism for their retrieval, then fewer partitions are required, on the other hand, if greater details are part of the requirement, the images can have greater number of partitions. Images can be partitioned in a plurality of ways as well. For instance, every time a rule is applied (filters, color change, etc.) then the partitioning is applied, a single partition, four partitions, one hundred partitions, etc.

If an image is partitioned into four partitions [1] then one thousand partitions [2], once selecting the input image a quarter of the first indexed partitions can be selected [1] then within the selected partition select the individual partitions for the second indexed partitions [2]. This way the algorithm will first apply rules for the first selection then the second selection and by doing it this way a more precise matching can be accomplished. That is, the first search will be performed and seek the quarter of images' partitions then the individual partitions from the quarters partitions that was found are searched thereafter. Also, instead of having images partitions checksum, the actual byte values for the image can be used for indexing it, if the image has 256 colors than one byte value will be used for each pixel, for 65536 colors two byte values will be used for each pixel, all the bytes values can be used as well for the entire partition.

IV) Partitioning Based Text Indexing

There are many ways of using the partitioning mechanism that we've presented so far for indexing digital stream (images, digital video and digital audio) and one way which it can be used is to index a text just like any other type of digital-data stream. Text usually is indexed by having some or all of page-words content indexed and available for searching based on their words value or their words proximity to each other. There are some instances however that a part of a page needs to be indexed and searched without the currently in use methodology. For instance, if the page is a book and the user needs to locate the book in its digital format and the user knows portions of the book, maybe the user has a photocopy of a page of it, know by heart, has a page retrieve from a digital format, etc., and if the partitioning process is used for indexing a book, all the user will have to do is type portion of the page and that portion will be converted in its partition value and the book will be found in a split of the time it would've by using the currently in use process.

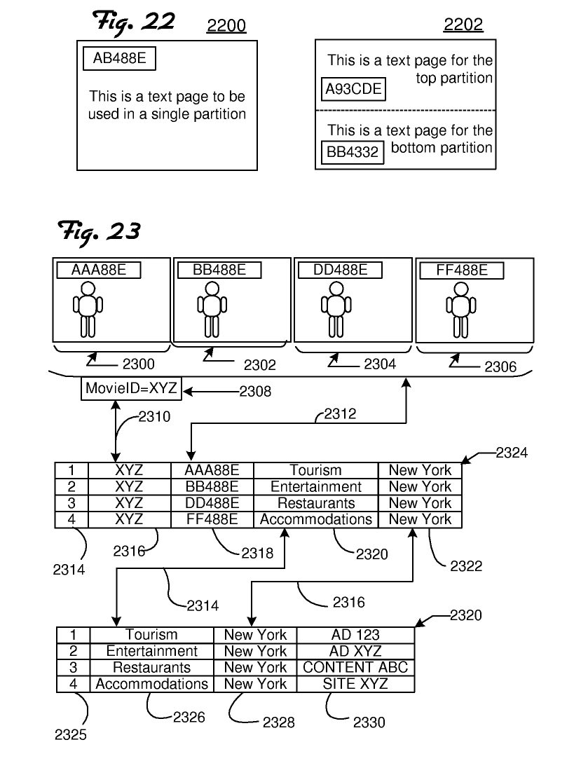

As with the digital stream, the text stream can be indexed in any way and the same process used for indexing it, will be used for searching-retrieving it as well. As we now turn our attention to FIG. 22 and it illustrates what we've just described. The first FIG. 2200 illustrate a page indexed and having a single partition, as for the second FIG. 2202 it is partitioned twice then indexed. In the example of a book, it can be partitioned in any possible way, by partitioning every page, or just the first page of each chapter, having pages partitioned in quarter pages, etc., and once again, the same process used for partitioning and indexing must be used for the input-search text stream as well.

V) Modes of Using Indexed Partitions

By far we've presented ways of using the partition indexing/retrieval mechanism for digital stream and as we proceed, it will become clear that there are many more ways of using this great invention and enhance the way documents of all sort are indexed and retrieved. As we turn our attention to FIG. 23 it illustrates a movie clip having four images and each one single-partitioned. Each partition having its partitioned values, for image 2300 the partition value is “AAA88E”, for image 2302 the partition value is “BB488E”, for image 2304 the partition value is “DD488E” and for image 2306 the partition value is “FF488E”. In the present illustration as the algorithm partitions each image (it can be more than one image) the user will be able to provide to the algorithm ways of describing the meanings for each image or a group of images, meanings like a category, subcategory, group, etc., and these meanings given to each image or a group of images will enable the system projecting the video stream ways of relating content to the displayed video content. The same is true for still images and digital audio, as we'll see shortly.

As we now focus our attention to FIG. 23 and bellow the video clip there is the clip's id “MovieID=XYZ” 2308 and it is related to column 2316 (arrow 2310) of table 2324. Table 2324 has a rows column 2314, the movie-clips id column 2316, the partitions' values column 2318, the subcategory's code-values 2320 and the category's code values 2322. Now, table 2324 is a table that is created at the time the movie clip is partitioned and the values for the subcategory column 2320 and the category column 2322 is system provided in similar fashion like a dropdown, a selection box, a check box, etc., or it can be user provided, like words that describe sections of the movie clip (subcategory) and for the complete movie clip (category).

Lets say that the movie clip 2308 is about a trip to New York. Portion of the clip is related to a user experience arranging the actual trip to New York, another part of the clip show the night life and entertainment of New York, one other shows restaurants the user dined, and yet another shows the hotel where the user stayed. In the just described scenario, the user can select a category for the video clip as New York 2322 as for subcategory 2320 the user selects “Tourism” for image 2300 (row #1 table 2314), “Entertainment” for image 2302 (row #2 table 2314), “Restaurants” for image 2304 (row #3 table 2314) and “Accommodations” for image 2306 (row #4 table 2314). Once again, these selections can be done as the user is viewing the movie clip and the algorithm is parsing it (doing the partitioning), the user can stop the clip at any time and select subcategories, categories, type related words, etc. As the user does the interaction the information is recorded in a database table or any other means, in our example is it's a database table 2324. This is but one way and it is illustrated here for the purpose of explaining this invention and many more mode of use can be implemented without departing from its true spirit. It can be a video stream, images, text stream, digital-audio stream, slide presentation stream, etc.

As the movie clip plays and a user viewing the clip decides to interact with the system playing the movie (it can be a computer, television, hand held devices, computers connected to the Internet, etc.), other related contents can be displayed to the user as another movie clip or as any kind of available content format. Lets now say that the user clicks a button, link, or something of that sort, at the time the movie is playing about the moment the user was preparing for the New York trip, after the user selects a link of some sort the user will be taken to the related content, the content of row #1 of table 2320, subcategory column 2326, category column 2328 and related content at column 2330 will be presented to the user. It might be related to travel agencies specialized in New York tourism, or other type of related information to the category “tourism” and “New York”, and advertisings of all sorts. However, this is but one way, the collection of links for all related contents of table 2324 for the playing video clip “XYZ” can be displayed along with the content, a video clip in our explanation, links of related contents can be selected any time the clip is playing, before the clip plays, after the clip has ended playing, displayed on the same, on a separate page, on a popup window, etc.

Lets briefly review table 2320 and it illustrates its relationship with table 2324, for subcategory relationship 2314 (column 2326), for category relationship 2316 (column 2328), the related contents are stored in column 2330, and rows for each content is at rows column 2325. Table 2320 can have other columns as well, like, a column to store user provided words, other website link directing to websites/webpages, etc. This is a very simplistic way of presenting this invention and anyone skilled in the art will readily appreciate that there are many more ways of implementing it without departing from its true spirit and scope. It is done as is for sake of simplicity and not intended to obscure the invention and its true meanings.

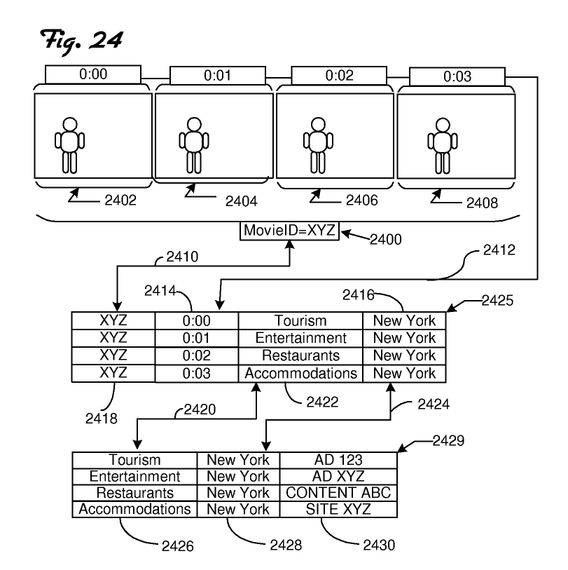

There is at least one more way of using the above described means for providing related content to a digital stream (audio, video, books, image, etc) by having means for a user to provide information regarding the digital stream and as we turn to FIG. 24 it illustrates just one more way of doing it. Similar video clip is illustrated and having images 2402, 2404, 2406 and 2408 for the “MovieID=XYZ” 2400. As we look over on the top of each image a time box is illustrated and it means that the user can provide information based on the timing of the movie play.

Lets continue with the movie clip about New York. The user can stop the movie clip at any time and provide the category, subcategory, type related words, etc, and as they are provided they will be saved at a database or any other means. Instead of playing the movie and having it stopped to provide the information, the user can simply provide them based on the timing of its play. For instance, for the first minute the user may provide a string in an entry text field that says: “0:newyork:tourism:xyz” (or any other format) and the string will be parsed into the first row of table 2425 and once the movie clip is played and the user clicks on some kind of link (explained already for FIG. 23), the related content on the first row of table 2425 will be presented to the user. Since tables 2425 and 2429 are very similar to tables 2324 and 2320 of FIG. 23 except for column 2414 that is related to the timing part of the video clip, and since FIG. 23 has already been explained, any one skilled in the art will be able to follow them based on the explanation already given and fully understand its meanings as well. Once more, the information can be user provided in any possible way and only limited to the human imagination, as long as it achieve the process in providing related content based on the timing of the movie play, its end results is thus the same.

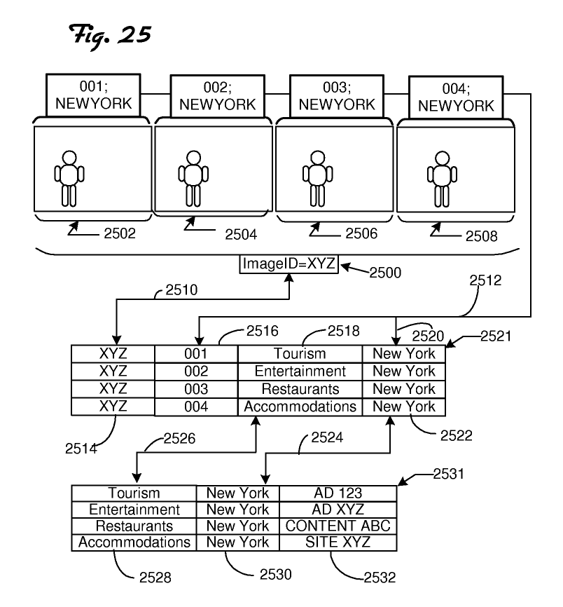

As we now turn to FIG. 25 it illustrates but one more way for a user providing information to a video clip and this time by a user providing code to the part of the movie clip. Since this figure is like FIGS. 23 and 24 and the explanation applies to it as well. We'll only explain the top boxes over each image and column 2516 of table 2521. Lets take the first image 2502 the top box is a user provide information and instead of having a partition value or playtime associated with the movie-clip content, it has a user provided values, and for the first box 2502 it is “001:NEWYORK” and the system will have ways of associating the code “001”to the subcategory of “Tourism” first row of column 2516 of table 2521. This is but one more way, it may just have the codes without any other values, like “001” alone and “NEWYORK” not present.

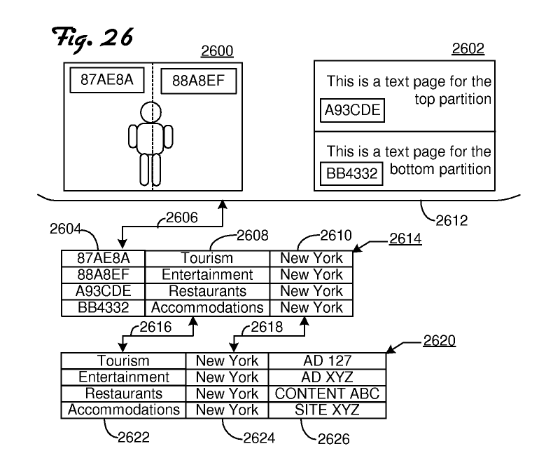

As we now turn to FIG. 26 illustrates but one more way for content relationship with the data stream and at this time as it is illustrated, text and images are used for relating content to them. This figure is very similar to FIGS. 23, 24 and 25 and presented here to show the many ways of using the partitioning mechanism of this invention and the many ways of presenting related contents to a user provided content. The explanation of FIG. 23-26 applies to it as well.

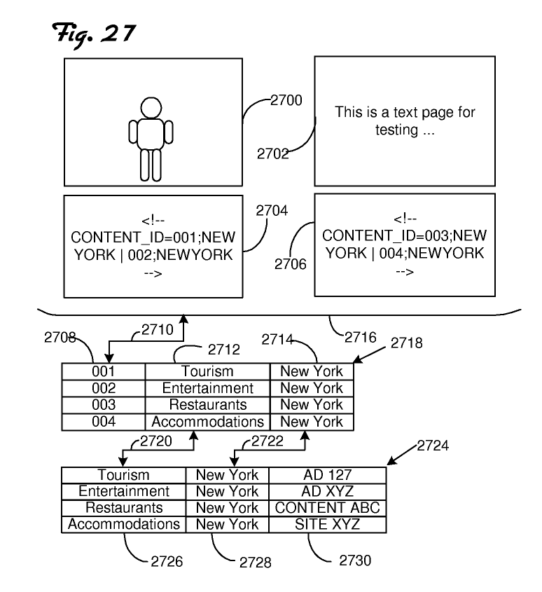

As we turn to FIG. 27 it illustrate but one more way of relating contents to a user provide content stream and it is a further illustration of FIG. 26 and this time the information is embedded into the user provided content page by means of embedding the codes into the page, it can be in any form of embedding code to a page. In this particular case, at the time the page is loaded the systems, it will process and index it as needed. It could as well have been like: “<!—Category=newyork; subcategory=turism, entertainment, restaurants; words=night, life, food, entertainment;—>”

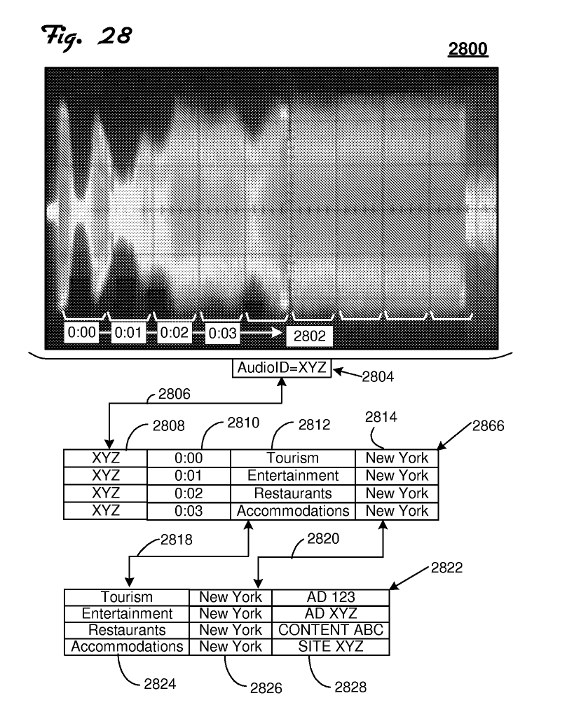

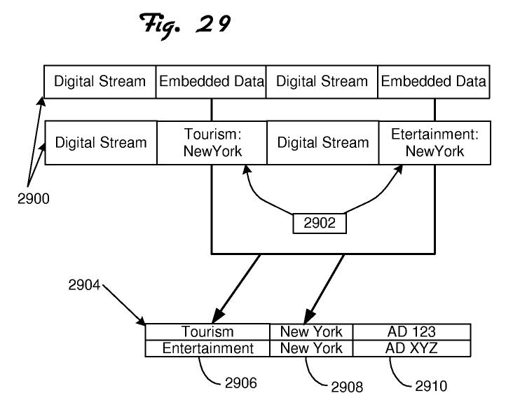

As we turn our attention to FIG. 28 it is a further illustration of FIG. 24, except this time, a video stream is used and its timing is used by the user to provide information pertaining to content relationship. The same processes presented throughout regarding partitioning, timing, user providing related words, user making the selection, etc., for providing means for relating content to a user provided content page, applies to any content format now in use or later to be developed, including but not limited to: video, audio, text, binary, etc. Also, the text content can be magazines, newspapers, books, websites, web pages, and any other content in the text-digital format.

User supplied data can be embedded directly to a digital stream and the process involves what we've already explained. At any time the digital stream can be stopped and data related to contents can be embedded into sections of the digital stream. As we turn our attention to FIG. 29 it illustrates a digital stream 2900 and its embedded data 2902 related to the contents table 2904 and table 2904 having a content subcategory column 2906, content category column 2908 and contents column 2910. As the digital stream 2900 is presented to a user the embedded data is extracted and related to the external content table 2904. However, the embedded data can be extracted any time the digital stream is used in a presentation. It can be before its presentation, while it is being presented, after it is presented and links to the contents can be displayed on the content page at any time, as well. Also, the embedded data can be extracted and indexed as depicted for the explanation of the previous drawings. Once again, the digital stream can be of any kind of data in the digital format.

As it is obviously to those of the skill in the art, the present invention can be used in a single device, multiple devices, on a computer network, over the Internet, etc. As well, an end user can apply rules to the digital stream (digital audio, digital video, text, image, slide presentation, etc.) then upload it to the computer/server doing its parsing, indexing and savings. The rules can be any of the rules described throughout the specification of this invention. Furthermore, the user may simply provide the related information in some means of supplying information on a webpage then upload the digital stream and the select/supplied rules to the server and it will apply the rules thereto.

Also, at the time of upload/provide, the user can select the type of contents that will need to be related to the digital stream (category, subcategory, related words, etc.), for instance, the user may select or type the timing related data to the digital stream about the related content's type (e.g. “0:001|turism|newyork”, “0:02|restaurants|newyork”, “0:03|accommodation|newyork”, etc.—please see FIG. 24). Once the digital stream and the user-provided data are receive by the server, then the saving of the digital stream, it's parsing and parsing of the user provided data will take place as previously taught.

Once the digital stream is presented to a user—on a computer or website—and the user interacts with it, the contents related to the digital stream can be presented to the user in any conceivable way and not necessary needs to be playtime related, that is, all related contents can be presented at once or as the digital stream interaction proceeds, it can be links to other websites, portion of the content, the complete content, after it has finished playing, etc. As well the content can be hosted at a content-hosting server over the Internet/network and the user interaction done though a client connection with it, or, it can be in a single location as well without departing from the true spirit, scope and meanings of the present invention.

The partitioning of a digital-content stream can be done on a client computer then its result uploaded to the server computer, it can be done at the server computer after is received by the client computer or a combination thereof. As well the end user at a client computer can select parts of the image as has been taught throughout and the selection sent to the content-hosting computer and it can be done by using JavaApplets, ActiveX, JavaScript on the client computer, etc.

### CONCLUSION

A method and apparatus for indexing, searching and matching still images, text, digital audio and video where rules are applied before their indexations, then they are partitioned and a means for producing individual values for each partition is applied (checksum) and the values are saved into an indexed database. The same rules are applied at the input counterpart as to produce identical values for the selected partitions of the input digital stream then perform a search and match against partition values stored at the database. As well means to associate content to a content-stream partition based on the partitions values, user supplied descriptive words, timing regarding the length of presentation of the content stream, etc.

Although the present invention and its advantages have been described in detail, it should be understood that various changes, substitutions and alterations could be made herein without departing from the true spirit and scope of the invention as defined by the appended claims. Moreover, the scope of the present application is not intended to be limited to the particular embodiments of the process, machine, manufacture, composition of matter, means, methods, computer software and steps described in the specification. As one of ordinary skill in the art will readily appreciate from the disclosure of the present invention, processes, machines, manufacture, compositions of matter, means, methods, computer software, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, computer software or steps.

What is claimed is:

1. A method for partitioning a digital stream, comprising:
a digital stream;
means for partitioning said digital stream;
wherein said means to partition said digital stream will partition said digital stream into at least one digital partition;
means for applying a rule at a digital partition as to produce a value representing the digital partition which the rule is applied to;
wherein said rule is applied to said at least one digital partition and a value produced; and
wherein said value is used for representing said at least one digital partition for its indexation in a searchable electronic format.

2. The method for partitioning a digital stream according to claim 1 wherein said digital stream is a digital audio stream.

3. The method for partitioning a digital stream according to claim 1 wherein said digital stream is a digital video stream.

4. The method for partitioning a digital stream according to claim 1 wherein said digital stream is a digital text stream.

5. The method for partitioning a digital stream according to claim 1 wherein said digital stream is a digital image.

6. The method for partitioning a digital stream according to claim 1 wherein said means to partition said digital stream will partition said digital stream into a plurality of partitions;
wherein said means for applying a rule is applied to said plurality of digital partitions;
wherein said rule will produce a unique value for each digital partition of said plurality of digital partitions; and
wherein each of said unique value represent individual digital partitions of said plurality of partitions.

7. The method for partitioning a digital stream according to claim 1 wherein said value was a result of a checksum algorithm applied to said at least one partition.

8. The method for partitioning a digital stream according to claim 1 wherein said rule is a means for enlarging said partition.

9. The method for partitioning a digital stream according to claim 1 wherein said rule is a means for reducing said partition.

10. The method for partitioning a digital stream according to claim 1 wherein said rule is a means changing colors.

11. The method for partitioning a digital stream according to claim 1 wherein said rule is a means for skewing said partition.

12. The method for partitioning a digital stream according to claim 1 wherein said rule is a means for changing said partition x-y axis coordinates within a predefined area.

13. The method for partitioning a digital stream according to claim 1 wherein said searchable electronic format is a database.

14. The method for partitioning a digital stream according to claim 1 further comprising:
a database;
said partition's value is stored at said database;
a tangible storage media; and
said digital stream is stored at said tangible storage media.

15. The method for partitioning a digital stream according to claim 14 further comprising:
a additional digital stream;
means for partitioning said additional digital stream into at least one additional digital partition;
means for applying a rule at said at least one additional digital partition of said additional digital stream as to produce a value representing said at least one additional digital partition of said additional digital stream;
said value representing said at least one additional digital partition is used for searching said at least one digital partition's value stored at said database; and
said search will produce an exact match between said at least one digital partition's value and said at least one additional digital partition's value.

16. A method for associating contents to a digital stream, comprising:
a digital stream;
at least a first computer and said at least a first computer having at least one tangible storage media therein;
means to partition a digital stream into digital partitions;
wherein said means to partition a digital stream will partition said digital stream into at least one digital partition;
means to associate a value to a digital partition;
wherein said means to associate a value will associate a value to said at least one digital partition of said digital stream;
at plurality of contents;
means for a user to provide information, the provided information is related to a digital partition;
a user;
said user uses said means to provide information and provides information related to said at least one digital partition;
means to save said user provided information related to said at least one digital partition on said at least one tangible storage media of said at least a first computer; and
means for associating said user provided information to said at least one digital partition's value of said digital stream and at least one content of said plurality of contents.

17. The method for associating contents according to claim 16 further comprising:
an additional user;
at least a second computer;
said additional user at said at least second computer initiates a request for said digital stream from said at least a first computer; and
said additional user views a content page at said at least second computer that was formatted by said at least first computer, said formatted content page at said at least second computer having said digital stream and at least a portion of said at least one content that is associated with said digital stream through said digital stream association with said at least one partition's value.

18. The method for associating contents according to claim 16 wherein said digital stream is a digital image.

19. The method for associating contents according to claim 16 wherein said digital stream is a digital audio.

20. The method for associating contents according to claim 16 wherein said digital stream is a digital video.

21. The method for associating contents according to claim 16 wherein said digital stream is a digital text.

22. The method for associating contents according to claim 16 wherein said value is a check sum of said at least one digital partition.

23. The method for associating contents according to claim 16 wherein said value is a time based value.

24. The method for associating contents according to claim 16 wherein said value is a user provided code.

25. The method for associating contents according to claim 16 wherein said value is embedded data value into said digital stream.

26. The method for associating contents according to claim 16 further comprising:
wherein said means to partition a digital stream will partition said digital stream into a plurality of digital partitions;
said user uses said means to provide information and provide information to each digital partition of said plurality of digital partitions;
wherein said means to associate a value will associate a distinct value to each digital partition of said plurality of digital partitions; and
means for associating each of said user provided information to a distinct digital partition's value of said plurality of digital partition of said digital stream and having at least one content of said plurality of contents associated to each digital partition's value of said plurality of digital partitions of said digital stream.

27. The method for associating contents according to claim 26 further comprising:
an additional user;
said additional user initiates a request for said digital stream from said at least a first computer; and
said additional user views a content page that was formatted by said at least first computer, said formatted content page having said digital stream and at least a portion of at least one content that is associated with at least one digital partition's value of said plurality of digital partitions of said digital stream.

28. A method for producing ratio of an image contour, comprising:
an image having at least two colors;
a tangible storage media;
an identification means associated with said image as to identify said image;
means to scan the y-axis coordinate of said image's pixels looking for a color change, once a color change is found record the y-axis value of said pixel location of said image where said color change occurred;
means to scan a different y-axis coordinate of said image's pixels looking for the same color change that was found by the previous scan;
if the same color change is found and its pixel location is at a different x-axis coordinate than the x-axis coordinate related to the y-axis coordinate having its value recorded thereto, save said x-axis coordinate value for the pixel location;
means to apply a mathematical calculation using said x-axis value stored therein and said y-axis value stored therein and said calculation result is a ratio between said x-axis value stored therein and said y-axis value stored therein; and
means to associate said ratio value with said identification means associated with said image and store said identification means and said ratio value on said tangible storage media in an electronic index-search format.

29. The method for producing ratio of an image contour according to claim 28 wherein said mathematical calculation is a division between the x-axis value and the y-axis value (x/y).

30. The method for producing ratio of an image contour according to claim 28 wherein said mathematical calculation is a division between the y-axis value and the x-axis value (y/x).

31. The method for producing ratio of an image contour according to claim 28 wherein said electronic index-search format is a database.
